(19) United States
(12) Patent Application Publication
(10) Pub. No.: US 2016/0117698 A1
(43) Pub. Date: Apr. 28, 2016

(54) System and Method for Context Dependent Streaming Services

(71) Applicant: Toushay Inc., Ottawa (CA)

(72) Inventors: Eric Kitchen, Montreal (CA); David Seguin, Ottawa (CA); David Andrew Waugh, Sydenham (CA); David Lee Read, Ottawa (CA); Steven Todd Gamble, Ottawa (CA)

(21) Appl. No.: 14/813,680

(22) Filed: Jul. 30, 2015

Related U.S. Application Data
(63) Continuation of application No. 14/067,315, filed on Oct. 30, 2013, now abandoned.
(60) Provisional application No. 61/842,643, filed on Jul. 3, 2013.

(51) Int. Cl. G06Q 30/02; G06Q 10/08; G06Q 30/06; H04L 29/08

(52) U.S. Cl. CPC G06Q 30/0202; H04L 67/02; H04L 67/10; G06Q 10/087; G06Q 30/0641

(57) ABSTRACT

What is disclosed is a system to deliver at least one of content and services to a first device based on the first device's context, the system comprising a cloud service coupled to the first device by a network, wherein the cloud service obtains information from the first device over the network; determines context of the first device based on information obtained from the device; assembles a package based on the determined context, said package comprising at least one of content and services; and sends the package to the first device over the network.

### FIELD OF THE INVENTION

The present disclosure relates to the provision of content and services based on the context of a particular user.

### BRIEF SUMMARY

A system to deliver at least one of content and services to a first device based on the first device's context, the system comprising a cloud service coupled to the first device by a network, wherein the cloud service obtains information from the first device over the network; determines context of the first device based on information obtained from the device; assembles a package based on the determined context, said package comprising at least one of content and services; and sends the package to the first device over the network.

A method for delivering at least one of content and services to a first device based on the first device's context by a cloud service, the cloud service coupled to the first device by a network, further wherein the cloud service comprises a processing subsystem, an analytics subsystem, a database, a context analysis subsystem and an external communications subsystem, the method comprising obtaining information from the first device over the network, the obtaining performed by the external communications subsystem; determining context of the first device based on the information obtained from the device, the determining performed by the context analysis subsystem; assembling a package comprising at least one of content and services based on the determined context, the assembling performed by the processing subsystem; and transmitting the package to the first device over the network, the transmitting performed by the external communications subsystem.

The foregoing and additional aspects and embodiments of the present disclosure will be apparent to those of ordinary skill in the art in view of the detailed description of various embodiments and/or aspects, which is made with reference to the drawings, a brief description of which is provided next.

### BRIEF DESCRIPTION OF THE DRAWINGS

The foregoing and other advantages of the disclosure will become apparent upon reading the following detailed description and upon reference to the drawings.

FIG. 1 is a diagram of one example of a prior art system.

FIG. 2 is a diagram of another example of a prior art system.

FIG. 3 is a diagram of another example of a prior art system.

FIG. 4 is a diagram showing a model of information retrieval using the system and method which is the subject of the specification.

FIG. 5 is a detailed diagram of the system and method which is the subject of the specification.

FIG. 6 shows a flowchart of one embodiment to perform assembly of a package depending on context.

While the present disclosure is susceptible to various modifications and alternative forms, specific embodiments or implementations have been shown by way of example in the drawings and will be described in detail herein. It should be understood, however, that the disclosure is not intended to be limited to the particular forms disclosed. Rather, the disclosure is to cover all modifications, equivalents, and alternatives falling within the spirit and scope of an invention as defined by the appended claims.

### DETAILED DESCRIPTION

This specification details a system and method for pushing information and/or functionality/services to a device based on the context of the device. In general, the context of an entity is information describing the past environment; present environment; or the past and present environments surrounding the entity in the digital and physical worlds. Then the context of a device is information describing the past environment; present environment; or the past and present environments surrounding the device in the digital and physical worlds.

In one embodiment, the context of the device additionally comprises the context of the one or more users who utilize the device. The context of a user is information describing the past environment; present environment; or the past and present environments surrounding the user in the digital and physical worlds. This encompasses information such as user location, time of day, time of year, season, user motion, user search history, weather experienced by a user, loyalty programs that the user is part of, past history of the user, past interaction history of the user with a particular vendor, relationship with device being used, whether the device is fixed or mobile and so on. Context can provide deep insights into what a user may want to do, see, hear, purchase, browse, and so on.

The environment of the device is highly dependent on whether the device is designed for high level of interaction with one or more users, or for a case of limited/no interaction. In the case of a high level of interaction, the environment of the device further depends on whether a single user interacts with the device; or a plurality of users interact with the devices. Examples of an individual user interacting with a device are, for example, a smartphone, laptop, personal computer, wearable device such as Google® Glass®, or tablet used by an individual. In one embodiment, the context of the device comprises the context of the individual user. This could also include, for example, the history of past interactions between the individual user and the device.

Examples of a plurality of users interacting with a device are, for example, customers using a kiosk in a supermarket; and employees using a shared/common tablet, smartphone, laptop, wearable device, or desktop computer in a store. Then, in one embodiment, the context of the device comprises the context surrounding the plurality of users using the device. This could include, for example, the collective characteristics of historical interactions between the plurality of users and the device.

It is also possible that while a device may be designed for interaction with a plurality of users, the same device may then be temporarily used for interaction with a single user. For example, while 2 or more wait staff in a restaurant may share a tablet, if one of the wait staff is using the tablet, then this individual may, for example, login using a username and/or password, or scan a Quick Response (QR) code, a Near Field Communications (NFC) tag, or use any other means of authentication. By doing so, the context of the tablet is changed to include the context of the single user. In such a situation, the context of the device comprises the collective characteristics of historical interactions between the plurality of users and the device, and additionally the characteristics of historical interactions between the single user and the device.

Examples of devices with limited or no interaction include digital signage displays, menu displays, digital billboards and digital display terminals. Then, the context of the device includes, for example, the location of the device and the collective characteristics of users who utilize the device. For example, the context of a digital sign in a café may include the composition of the café patrons based on frequency of visit. The frequency of visit for each patron can be obtained by, for example, viewing previous check-in data.

In one embodiment, context comprises information about venue. A venue is a geo-fenced area, which can be a store, concert stadium, outdoor venue, city blocks, suburb, or a metropolitan area. In one embodiment, a venue comprises a plurality of geo-fenced sub-areas. In a further embodiment, the plurality of geo-fenced sub-areas are linked. For example, the sub-areas could be physically contiguous, or linked by a common theme. An example is a music or film festival within a city, where different shows are held at different locations throughout the city. Then the geo-fenced sub-areas are the various locations, and the venue is the combination of these geo-fenced sub-areas.

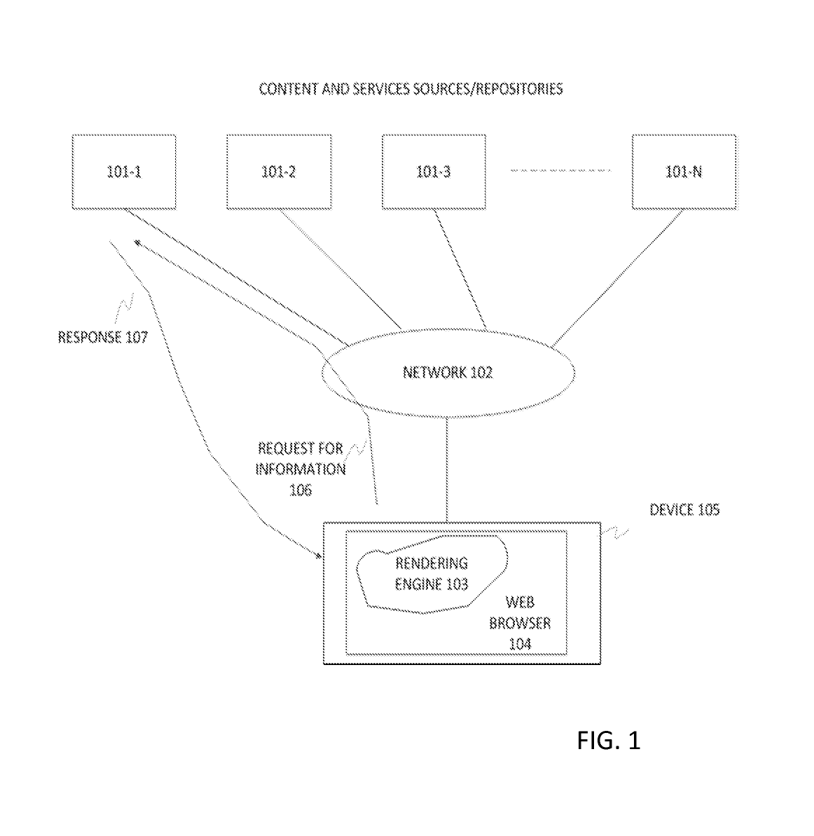

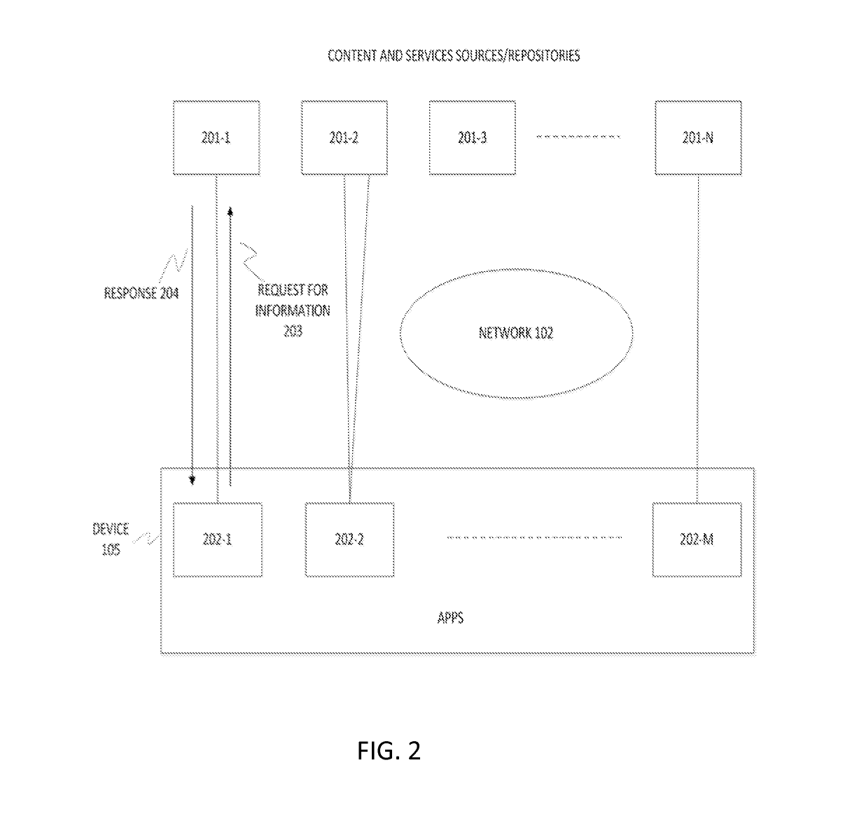

FIGS. 1 and 2 describe prior art systems for the situation where there is a high level of interaction between an individual user and a device. FIG. 1 shows a prior art system based on a web browser. This is “pull based”, that is, it is based on request-response protocols, for example, the Hyper Text Transfer Protocol (HTTP). In FIG. 1, there are several content and services sources or repositories 101-1 to 101-N, where information is stored.

Then, a user using device 105, utilizes web browser 104 comprising, for example, a web browser or web rendering engine 103, to make a request for information 106 over network 102 from content and services source or repository 101-1. Device 105 is, for example, a mobile or a fixed device. Device 105 could be, for example, a tablet, smartphone, laptop, kiosk located at a particular location of a retail outlet, or a personal desktop computer. Network 102 is, for example, the Internet, intranet, wide area network, virtual private network, telephone or local area network. In addition, the network 110 could be a wireless, wired, satellite, optical network or use any form of physical media. The network 110 may itself be comprised of two or more interconnected sub-networks. A response 107 is sent to the device 105 containing information requested by the user.

This model suffers from the following problems: Firstly, a user has to know the location of the content source 101-1, so as to make the request 106 for the information with the device 105. The location of the content source 101-1 is given by an address, such as a Uniform Resource Locator (URL).

Secondly, a user would have to interpret his or her context himself, to make a request for information. For example, if a user needs to find information about which stores sell umbrellas nearby because it is raining then the user would have to search for websites of stores which sell umbrellas, then make requests for information such as finding out which ones are open, looking up their location, see if they have the item in stock, from those websites. That is, the user has to interpret his or her context, then make requests for information, collate the data himself or herself, analyze the collated information and decide on the best course of action. This may result in suboptimal decisions being made by the user, as a user may not properly collate all the information, or may perform an imperfect analysis due to, for example limited knowledge.

Third, a user can only make requests for information based on his/her limited current knowledge. For example, in the case of trying to find a store selling umbrellas, the user may not realize that there are better options than umbrellas to protect himself or herself against rain. The user may expand his/her current knowledge by, for example, performing information searches, but these may be time-consuming. Additionally, the results returned will depend on the skill of the user in selecting search terms.

Finally, in the case of wearable devices with limited user input capability, it may not be easy for a user to enter in URLs or search terms to find relevant information. A system to facilitate pushing of information relevant to the context of the user without requiring too much input is especially advantageous in this context.

Additionally, this model offers very limited opportunity to tailor the content, services or applications delivered to the device based on the context of the device.

FIG. 2 shows another prior art model for a high level of interaction, this time based on applications or “apps”. This is also pull based. In FIG. 2, there are several content and services sources or repositories 201-1 to 201-N. A user using device 105, utilizes one of the apps 202-1 to 202-M, such as, for example, app 202-1; to make a request for information 203 over network 102 from, for example, content and services source 201-1. A user can utilize or activate the app by, for example, clicking or pressing on an app button or icon on a screen, or by using other gestures such as a voice command or a “heads up” for a wearable computing device. This will result in a response containing information. While this makes it easier for the user, it still does not solve the problem of a user having to request information based on his or her context. Also, it creates the problem of requiring that a user has a dedicated app for each service. For example, if the user needs to buy an umbrella, and identifies store X as a possible candidate, then the user must have an app for store X. If the user does not have the app, then the user must download the app. Furthermore, this means that the user must be able to identify store X as a candidate. Also, information cannot be customized to either context or venue. It also creates a problem of “app overload” on the screen of a device 105. This problem may be exacerbated for the case of a wearable computing device such as Google® Glass®, where screen size is extremely limited, and it is not easy for users to navigate a screen to find the apps that are important to them.

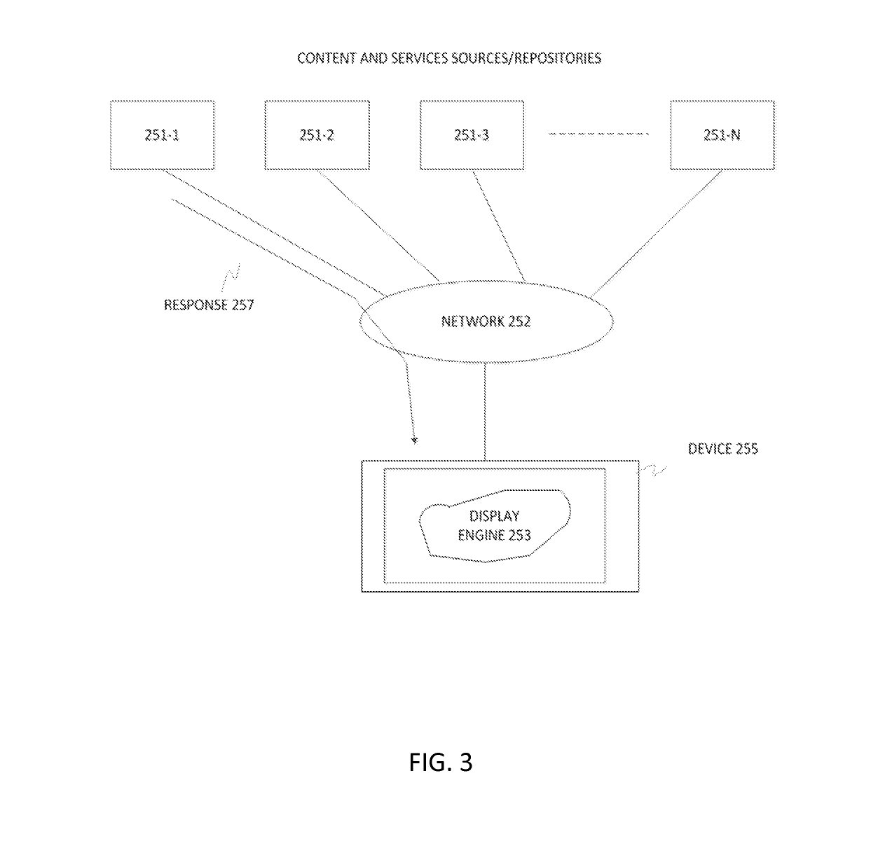

FIG. 3 shows an example, this time, of a device with limited or no interaction with a user. Content is drawn from sources/repositories 251-1 to 251-N, encapsulated within, for example, response 257, and periodically pushed to the device over network 252 so as to “refresh” the display on device 255. In another embodiment, similar to that of FIG. 1 the device automatically requests information from sources/repositories 251-1 to 251-N.

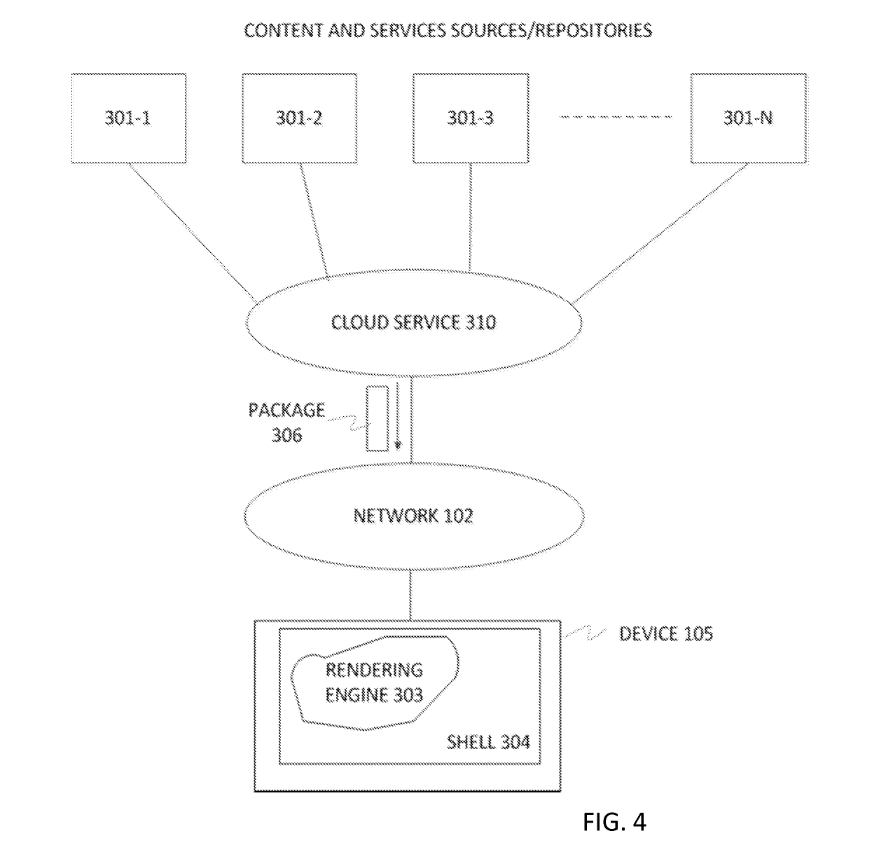

FIG. 4 shows a high level diagram of the system and method that is the subject of this specification. There are several content and services sources/repositories 301-1 to 301-N connected to cloud service 310. The device 105 has a “shell” 304 combined with a rendering engine 303. The shell 304 is a lightweight client program, which can run in the background of the device. In one embodiment, the shell is downloaded onto the device from an online application store, such as the Apple® App Store®, the Google® Play® Store®, or Blackberry® App World®. The shell 304 is integrated with the device 105 functionalities, such as the global positioning satellite (GPS), Bluetooth, Wi-Fi, camera, video and audio recording and gyroscope functionalities. In one embodiment, the shell 304 operates to capture information from these various functionalities/components of the device. In another embodiment, the shell 304 has processing capabilities, that is, it captures information from these functionalities/components and processes the information to produce new information.

The device 105, via shell 304, transmits information periodically to cloud service 310. Cloud service 310 performs the following functions:
Analyzing and using information sent from device 105 via shell 304, along with information from other external and internal sources, to determine the context for device 105.
Storing data pertaining to users of the cloud service, including, for example, data on previous interactions, loyalty club memberships, biographical data, contact information.
Assembling packages based on the context of the device
Performing analytics based on stored data and externally available data
Storing of content and branding for use in packages

Based on data obtained from the shell 304, the cloud service determines the context of the device. Cloud service 310 then retrieves information from one or more of the content and services sources/repositories 301-1 to 301-N and/or internal storage databases to assemble a “package” such as package 306 for the user, In one embodiment, the package comprises a collection of purely content. In another embodiment, the package comprises purely services. In a further embodiment, the package comprises a combination of both content and services. If the package comprises content, in one embodiment, the package comprises static content. In another embodiment, the package may comprise dynamic content. In a further embodiment, the package comprises a mix of static and dynamic content. If the package comprises services, in one embodiment, the package is a static set of services. In another embodiment, the package is a dynamic set of services. In one embodiment, the package contains one or more files written in Hyper Text Markup Language (HTML) 5.0, and a “manifest” written in, for example, JavaScript Object Notation (JSON). Further information on the formatting of the manifest is provided in, for example, http://developer.chrome.com/extensions/manifest.html retrieved May 29, 2013, and herein incorporated by reference as if reproduced in its entirety. In one embodiment, the manifest contains special information that helps device 105 to resolve branding, questions around which services to link to, and so on.

This package 306 is then pushed or streamed over network 102 to the device 105. Once the package is received at the device, the package and the shell interact with each other to provide context dependent content and/or services at the device. For example, if the user enters a certain venue with a device having an installed shell, then a package is streamed or sent to the device automatically. Once received by the device, the package interacts with the shell to, for example, provide the user with a choice of actions to perform.

The system of FIG. 3 offers several advantages over the prior art. Firstly, the cloud service 310 is better able to link information and services from various sources to the context of a device than previously, so as to better deliver information and/or services which have been customized to the device context.

Currently, a lot of information generated in a venue such as a shopping mall or a stadium is lost. One reason for this is because users do not want to download an app every time they enter a new place Another reason is because apps are not designed to interact while in a venue, except with the user. With the system of FIG. 3, details of specific interactions with users which are customers can be quantified and recorded, including while the user is in a venue. Previously this data, especially relating to in-venue experience, was not as easily captured. Having a context dependent streaming service could enable a vendor to retain and utilize this information to improve the customer experience. The ease of capture using such a system means that valuable information to enable more targeted analytics and opportunities to improve and resolve problems proactively can be recorded. For example, the time between a user requesting information on a given item within a supermarket, and being serviced by a representative can be recorded and acted upon in real time, while the customer is still within the venue. This information can be used both passively and pro-actively to help guide the user.

For example, if the user enters a venue, and has either previously indicated or indicates, using a device that he/she is looking for an item. If, for example, it is known that the item is out of stock within that venue, then an associate can be sent to the user to offer the option of, for example, ordering the item online and having it delivered to the user. This way, the user does not leave and go to another vendor. In another example, if the user is at a venue such as a branch outlet for a chain of quick serve restaurants, the user can be told what the average wait time is for that day at that location. The user can then be, for example, offered the choice of another location for that same chain, which has a shorter waiting time, so as to help prevent the user from going to a different vendor. In another embodiment, the interaction data for the user interaction at the venue is stored and used to determine new content and services to be pushed to devices.

In addition, with the advent of wearable devices such as smart glasses, information surrounding a retail experience can be easier captured and analyzed to understand context, and provide information to resolve or address customer problems proactively. For example: A shell is installed on a pair of smart glasses, and it captures video of a user in a supermarket. The footage is analyzed, and it is determined that the user is looking for a particular item. Then the cloud service will push a package containing, for example, an appropriately formatted item locator service to the wearable device.

Also, retailer-to-retailer context can be stored. For example, if a customer purchases cheese at one retailer, when the customer enters another retailer, a package containing matching wines can be pushed to the customer. This enables retailer cross selling, and allows for bidding on advertising spots for a customer from selected retailers.

Details of interaction from different platforms can also be remembered. This allows for better customization of packages. For example, if a user is checking items on a laptop at a particular retailer, and then happens to visit a branch store of the retailer, then a package containing the items of interest can be pushed to the retailer. As a consequence of this, the system allows for better tailoring of loyalty programs to customer context. As is known to many retailers, loyalty is truly built via experience and engagement with the customer. This system and method enables the building of “true” loyalty using one-on-one communications.

In a further embodiment, the shell is able to capture microblog posts made on various microblogging and social media sites, such as Facebook®, Twitter®, Google® Plus®, and send this information to the cloud service 310.

Third party websites operated by companies such as Facebook® and Google® can perform the same functions, for example, when a user explicitly checks in at a particular location, these third party websites will send context dependent information for surrounding vendors to the user. However this may mean that the information passes through these companies, where it may potentially be recorded. Vendors may not want to give up confidential or sensitive information to another corporation. The present system has the advantage of being able to provide both context dependent information and services in a confidential manner. In addition, the present system does not require the user to explicitly check in at a particular location.

Furthermore, in the case of wearable devices where there is limited screen space, it is especially advantageous to have mechanisms which facilitate the pushing of information relevant to the context of the user. This is because the user has limited capability to navigate and search for different apps, or enter multiple keystrokes to find information.

Because all information is stored by the cloud service, the system offers persistence. Even if a user loses a device, once the user has downloaded a shell to a new device, cloud service 310 can easily push packages to the new device.

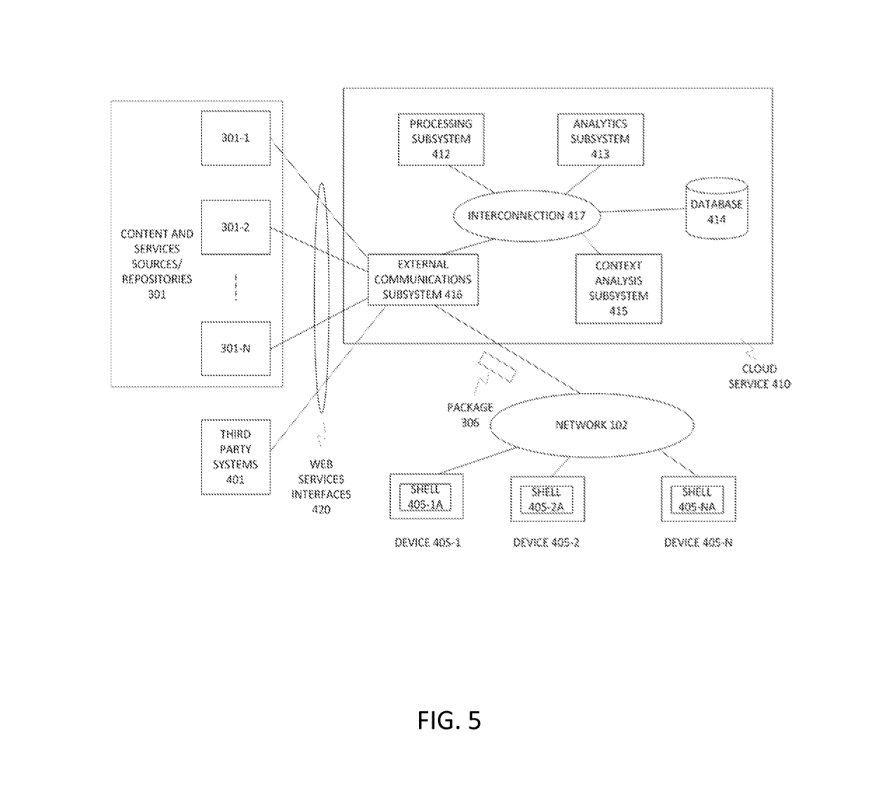

FIG. 5 expands on FIG. 4 and shows one embodiment of the system and method that is the subject of this specification. In one embodiment, this system uses mechanisms based around Hyper Text Markup Language (HTML) 5. In FIG. 4 there are several devices 405-1, 405-2 to 405-N. Some of these devices are meant for a high level of user interaction, and some for limited/no user interaction.

Each of devices 405-1, 405-2 to 405-N contain a corresponding shell 405-1A, 405-2A to 405-NA. In each device, as previously explained, the shell is integrated with the hardware features of the device.

Each of the devices is connected to cloud service 410 via the network 102. The cloud service 410 performs several functions, including:
Analyzing context of users
Assembling packages
Storing building blocks such as templates and modules for use in assembling packages
Storing data pertaining to users of the cloud service
Performing analytics based on internally stored data such as user data, as well as externally available data.

In one embodiment, cloud service 410 comprises several subsystems, including but not limited to processing subsystem 412, analytics subsystem 413, database 414, context analysis subsystem 415, external communications subsystem 416, and interconnection 417.

External communications subsystem 416 provides the functionality of establishing and managing all communications external to cloud service 410. This includes connecting the cloud service 410 to devices, content and services sources/repositories 301 and third party systems 401. In one embodiment, external communications subsystem 416 connects to content and services sources/repositories 301 and third party systems 401 via web service interfaces 420 which use technologies such as Representational State Transfer (REST)ful and Simple Object Access Protocol (SOAP). Examples of third party systems 401 include, for example, vendor communications systems, external analytics subsystems, vendor analysis subsystems, vendor databases, external websites, newsfeed databases, search engines and so on.

External communications subsystem 416 also receives communications from shells such as shells 405-1A to 405-NA installed on devices 405-1 to 405-N. In one embodiment, a shell such as shell 405-1A on device 405-1 contacts the cloud service 410 periodically, and provides information to the cloud service. The information sent to the cloud service 410 includes, for example, device specific information, the status of the user, location, positional information, motion information, current searches being performed and other information that the user may have volunteered to allow the shell to provide to the cloud service. External communications subsystem 416 also performs the function of transmitting packages to devices.

For example, cloud service 410 could be connected to a vendor communication system via external communications subsystem 416 which is part of third party system 401. Then, for example, if a user within the venue requests information about an item using a package installed on a device, information is sent to the vendor communication system. This differs from other services, for example, Foursquare ®, where the service is not within the venue, and is not connected to the employees within the venue, or to other vendor systems/software and databases which contain information on loyalty programs and so on.

Database 414 performs the function of storing data to be used internally by cloud service 410. This includes, for example, user data such as user account information, user permissions, financial information for transactions, personal information such as user physical address, user email address, and user login details; and interaction history for users across different platforms. It could also include device data such as device type, nature of user interaction with the device, device MAC address, previous interactions with other devices in proximity to that device, and other data relevant to the device. In another embodiment, the database also stores content for use in a package, such as, for example, digital signage images and videos, if for example there is no link to an external content source. In a further embodiment, database 414 may provide data to external parties such as third party systems 401 for use in analyses performed by these external parties. In another embodiment, as explained previously, data from interactions with a venue or a brand can be stored in database 414, and used to modify future packages to be pushed to the device.

Analytics subsystem 413 performs the function of analyzing data obtained from external sources such as that provided by a shell installed on a device, third party systems 401, content and services sources/repositories 301; and data stored internally, for example, on database 414, to calculate metrics, identify correlations and perform other relevant analyses. In a further embodiment, the analytics subsystem 413 provides results from these calculations and computations to external subsystems, such as, for example, third party systems 401 for use in performing calculations. For example, analytics subsystem 413 may calculate the time that a customer waits for service after making a request for an item in a supermarket, and then correlate this to a “likely satisfaction score” of the customer. A vendor analytics system may then contact analytics subsystem 413 via external communications subsystem 416 to retrieve the likely satisfaction scores.

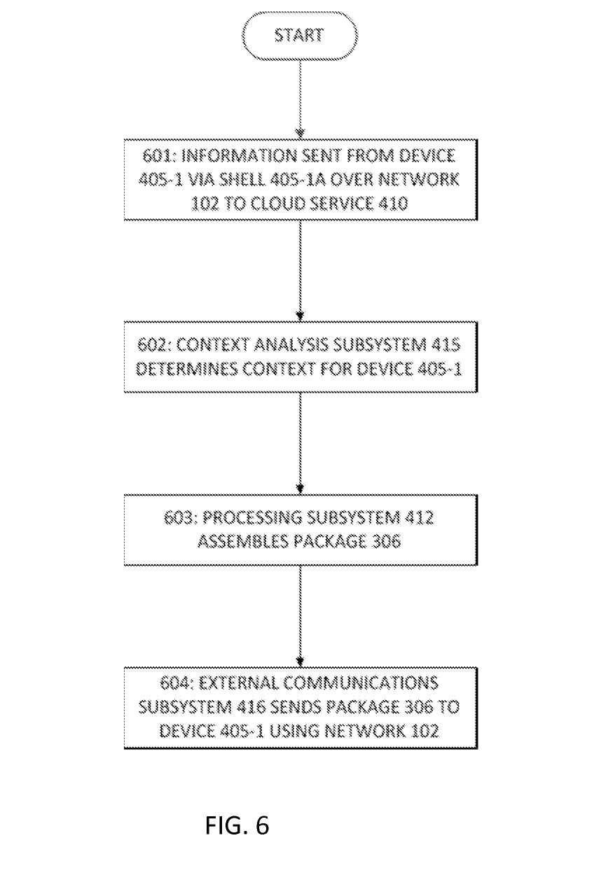

Context analysis subsystem 415 performs the function of collating and analyzing information to determine the context of an individual user or a group of users. Based on this, processing subsystem 412 assembles a package to send to a device. FIG. 6 shows a flowchart of one embodiment to perform this:

In step 601 of FIG. 6, information is sent from a device such as device 405-1 to the cloud service via the shell 405-1A installed on the device 405-1, and external communications subsystem 416.

In step 602 of FIG. 6, using, for example, the information sent from the device 405-1, data stored internally on database 414, and external sources of information such as third party systems 401; context analysis subsystem 415 determines the context for the device. Context analysis subsystem 415 may also use information sent from the shell of one or more different devices to determine context for a given device. For example, context analysis subsystem 415 may use information sent by shells 405-2A to 405-4A running on devices 405-2 to 405-4 to determine context for device 405-1.

In addition, context analysis subsystem 415 may perform the function of determining context for a device where there is interaction with a group of users, such as a kiosk at a supermarket. For example, if device 405-1 was a vendor kiosk, context analysis subsystem 415, based on the information provided by shell 405-1A installed at device 405-1, is able to determine the composition of regular users, users on a loyalty program and new users within the vendor's venue.

In another embodiment, context analysis subsystem 415 works together with analytics subsystem 413 to determine context for the device. For example, analytics subsystem 413 can collaborate with context analysis subsystem 415 to predict future context based on historical data. For example, in the case of a device such as a digital signage system used in a café, if based on historical data the composition of customers at a certain time in the future can be predicted, then information customized to that context can be provided, or information to assemble the appropriate packages for that time.

In step 603 of FIG. 6, based on this determined context, processing subsystem 412 assembles a package. In one embodiment, the processing subsystem 412 works together with context analysis subsystem 415 and optionally analytics subsystem 413 to help assemble a package such as package 306 to be transmitted to device 405-1. As explained previously, package 306 could comprise one of content and services, or a combination of content and services. If package 306 comprises services, then the services could either be static or dynamic. Processing subsystem 412 draws information to assemble the package from one or more of content and services sources/repositories 301; and/or information and content stored internally on database 414. For example, as mentioned previously, historical interaction data stored in database 414 can be used by the analytics subsystem 413 to determine the content and/or services to be pushed to future clients.

In one embodiment, the package contains template, content and data about devices registered to the customer, for example, type of device the package is being addressed to. In another embodiment, the package contains branding. In a further embodiment, the package contains one of a static, dynamic, or static and dynamic set of services.

A template is a collection of modules, or collection of services. A module is designed to perform standard functions. The template is customized according to context. In one embodiment, templates are also applied to services, unlike previous systems, where templates were only applied to content. Templates are stored, for example, on database 414 of cloud service 410. When required these can be used to assemble a package.

In one embodiment, a template is an abstract base class, and it is non-instantiable. In order to create an instance, the template must be extended by creating subclasses which are inherited from the base class. Then, an instance of the subclass is used to create a package, such as package 306.

In step 604 of FIG. 6, once the package is complete, the processing subsystem then sends the package 306 to external communications subsystem 416, which then sends on the package 306 to one of devices 405-1 to 405-N using network 102.

Interconnection 417 of FIG. 5 performs the function of linking processing system 412, analytics subsystem 413, database 414, context analysis subsystem 415 and external communications subsystem 416, to route data within the cloud service 410. Interconnection 417 is, any technology which could be used to connect these various systems together, including, for example, the Internet, intranet, data centre network, wide area network, virtual private network, telephone or local area network. In addition, interconnection 417 could be a wireless, mesh, wired, satellite, optical network or use any form of physical media. The interconnection 417 may itself be comprised of two or more interconnected sub-networks.

Various embodiments or implementations of cloud service 410 are possible. For example, in one embodiment, cloud service 410 is implemented using a server or servers. In another embodiment, cloud service 410 could itself be implemented in a cloud-based fashion. In other embodiments, it is implemented in software, hardware or a combination of software and hardware. Similarly, various embodiments of the components of cloud service 410 such as processing subsystem 412, analytics subsystem 413, database 414, context analysis subsystem 415 and external communications subsystem 416 are also possible. In one embodiment, these components are implemented using a server or servers. In another embodiment, these components are themselves implemented using a cloud-based implementation, in which case cloud service 410 could be a cloud comprising one or more sub-clouds. In other embodiments, these components are implemented in software, hardware or a combination of software and hardware. In addition, various software technologies and programming languages can be used in these implementations, such as Node.js server, J2EE, .NET framework, NoSQL, SQL, Java, JavaScript, Python, Ruby, C, C++, C#, and PHP.

An example of the operation of cloud service 410 is provided below: A digital signage display within a venue sends information regarding the time of day, its location, and type to the cloud service 410 via the shell installed on the display. This information is received by external communications subsystem 416, and is stored in database 414. Context analysis subsystem 415 retrieves this data, and together with analytics subsystem 413, determines that potential viewers of that digital signage display at the current time of the day are likely to be thinking about what to have for lunch. Then, the context analysis subsystem works together with processing subsystem 412 to, for example, build a package containing information about various lunch spots within the venue, as well as information about daily specials. The package is transmitted by external communications subsystem 416 over network 102 to the digital signage display, to show this information to potential viewers.

In another embodiment, the devices 405-1 to 405-N may be kiosks, with the shell installed, at a merchant's location. Customers interact with the kiosk for a number of different reasons, including searching stock availability in the store, to look at new product displays or advertisements, to obtain promotional information and material and/or to pay for purchases. The cloud service 410 receives and analyses the data from the different customer interactions to obtain various metrics such as inventory searched and inventory purchased. A smart template selector feature can be used based on the data from the various kiosks. For example, the data provides the merchant with metrics to determine the most popular or least popular inventory items in the store. This data can be analyzed using the context analysis subsystem 415 to determine the context of a group of customers and processing subsystem 412 assembles a customized package to deliver to the kiosk. The appropriate template for use based on the context of the customers may then be sent to the kiosk.

A merchant having multiple store locations or kiosks located in different geographic locations (ie: kiosks used for marketing and advertising) may compare usage between 2 or more kiosk locations or groups of kiosks. This will allow the merchant to determine the popularity of items based on product searches and purchases in a single location, multiple locations and/or online. The data from each kiosk is analyzed by the analytics subsystem 413 to determine the most searched and most purchased inventory items. The analysis results are sent to the merchant via the external communications subsystem 416 and the merchant may then prioritize inventory by most/least popular as well as prioritize reordering of stock depending on the results.

In another embodiment, the analytics subsystem 413 and the context analysis subsystem 415 at cloud service 410 make an analysis based on a variety of metrics collected from the devices, including waiting time, rate/flow, service delays, kiosk usage patterns (instant vs. long term use), etc. Based on the results of the analysis, the merchant may take a variety of actions. The actions may include providing product alerts, sending coupons to a customer's mobile device, reallocation of staff for venue and customer management, etc. Coupon and reward values could be based on the amount of information provided by the customer; for example, a 10% discount if the customer declines to provide information and a 35% discount if the customer signs up for a credit card.

In a further embodiment, social media specific to the community of the users can be set up. This allows for community discussions and forums to be set up. The discussions in these forum can be analyzed using, for example, analytics subsystem 413 and/or context analysis subsystem 415 to better customize packages to deliver to various devices. In addition, the discussions can also be utilized to improve shell design.

Although the algorithms described above including those with reference to the foregoing flow charts have been described separately, it should be understood that any two or more of the algorithms disclosed herein can be combined in any combination. Any of the methods, algorithms, implementations, or procedures described herein can include machine-readable instructions for execution by: (a) a processor, (b) a controller, and/or (c) any other suitable processing device. Any algorithm, software, or method disclosed herein can be embodied in software stored on a non-transitory tangible medium such as, for example, a flash memory, a CD-ROM, a floppy disk, a hard drive, a digital versatile disk (DVD), or other memory devices, but persons of ordinary skill in the art will readily appreciate that the entire algorithm and/or parts thereof could alternatively be executed by a device other than a controller and/or embodied in firmware or dedicated hardware in a well known manner (e.g., it may be implemented by an application specific integrated circuit (ASIC), a programmable logic device (PLD), a field programmable logic device (FPLD), discrete logic, etc.). Also, some or all of the machine-readable instructions represented in any flowchart depicted herein can be implemented manually as opposed to automatically by a controller, processor, or similar computing device or machine. Further, although specific algorithms are described with reference to flowcharts depicted herein, persons of ordinary skill in the art will readily appreciate that many other methods of implementing the example machine readable instructions may alternatively be used. For example, the order of execution of the blocks may be changed, and/or some of the blocks described may be changed, eliminated, or combined.

It should be noted that the algorithms illustrated and discussed herein as having various modules which perform particular functions and interact with one another. It should be understood that these modules are merely segregated based on their function for the sake of description and represent computer hardware and/or executable software code which is stored on a computer-readable medium for execution on appropriate computing hardware. The various functions of the different modules and units can be combined or segregated as hardware and/or software stored on a non-transitory computer-readable medium as above as modules in any manner, and can be used separately or in combination.

While particular implementations and applications of the present disclosure have been illustrated and described, it is to be understood that the present disclosure is not limited to the precise construction and compositions disclosed herein and that various modifications, changes, and variations can be apparent from the foregoing descriptions without departing from the spirit and scope of an invention as defined in the appended claims.

What is claimed is:

1. A system to deliver at least one of content and services to a first device based on the first device's context, the system comprising a cloud service coupled to the first device by a network, wherein the cloud service
obtains information from the first device over the network;
determines context of the first device based on information obtained from the device;
assembles a package based on the determined context, said package comprising at least one of content and services; and
sends the package to the first device over the network.

2. The system of claim 1, wherein one or more devices other than the first device are coupled to the cloud service over the network, the cloud service obtains information from the one or more devices other than the first device over the network, and wherein the determination of context further depends on the information obtained from the one or more devices.

3. The system of claim 1, wherein the context of the first device comprises one or more contexts corresponding to one or more users associated with the first device.

4. The system of claim 3, wherein the context of the first device comprises one or more characteristics of one or more historical interactions between the one or more users and the first device.

5. The system of claim 3, wherein the context of the first device comprises one or more characteristics of one or more users associated with the first device.

6. The system of claim 1, wherein the context of the first device comprises information associated with a venue.

7. The system of claim 1, wherein the first device comprises a corresponding first shell, and the information obtained from the first device is obtained from the corresponding first shell.

8. The system of claim 2, wherein the one or more devices other than the first device comprise one or more corresponding shells, and wherein the information obtained from the one or more devices other than the first device is obtained from the one or more corresponding shells.

9. The system of claim 1, wherein the cloud service comprises a processing subsystem, an analytics subsystem, a database, a context analysis subsystem and an external communications subsystem.

10. The system of claim 9, wherein the processing subsystem performs the assembly of the package.

11. The system of claim 9, wherein the context analysis subsystem performs the determining of context.

12. The system of claim 10, wherein the processing subsystem performs the assembly of the package based on interactions with the analytics subsystem.

13. A method for delivering at least one of content and services to a first device based on the first device's context by a cloud service, the cloud service coupled to the first device by a network, further wherein the cloud service comprises a processing subsystem, an analytics subsystem, a database, a context analysis subsystem and an external communications subsystem, the method comprising:
obtaining information from the first device over the network, the obtaining performed by the external communications subsystem;
determining context of the first device based on the information obtained from the device, the determining performed by the context analysis subsystem;
assembling a package comprising at least one of content and services based on the determined context, the assembling performed by the processing subsystem; and
transmitting the package to the first device over the network, the transmitting performed by the external communications subsystem.

14. The method of claim 13, wherein one or more devices other than the first device are coupled to the cloud service by a network, and further comprising obtaining information from the one or more devices over the network, the obtaining performed by the external communications subsystem, and further wherein the determining of context depends on information obtained from the one or more devices.

15. The method of claim 13, wherein the context of the first device comprises one or more contexts corresponding to one or more users associated with the device.

16. The method of claim 15, wherein the context of the first device comprises one or more characteristics of one or more historical interactions between the one or more users and the device.

17. The method of claim 15, wherein the context of the first device comprises one or more characteristics of one or more users associated with the first device.

18. The method of claim 15, wherein the context of the first device comprises information associated with a venue.

19. The method of claim 13, wherein the first device comprises a corresponding first shell, and the obtaining of information from the first device comprises obtaining information from the corresponding first shell.

20. The method of claim 14, wherein the one or more devices other than the first device comprise one or more corresponding shells, and wherein the obtaining of information from the one or more devices other than the first device comprises obtaining of information from the one or more corresponding shells.

21. A method to determine the popularity of an inventory item offered for sale by a merchant via a cloud service; the cloud service coupled to a plurality of devices at said merchant locations by a network, wherein the cloud service comprises a processing subsystem, an analytics subsystem, a context analysis subsystem and an external communications subsystem, the method comprising:
obtaining information from the plurality of devices over the network, the obtaining performed by the external communications subsystem;
said information comprising at least one of inventory items purchased and inventory items searched at said plurality of devices, and
Analysing said information from said plurality of devices to determine a quantity of said at least one of said inventory item purchased and said inventory item searched at each of the plurality of devices, said calculating performed by the analytics subsystem.
Determining from the analysis which of said inventory items are the most popular based on the quantity of at least one of said inventory item purchased and said inventory item searched at each of the plurality of devices, wherein the results of said analysis are sent to the merchant via the external communications subsystem.

22. The method of claim 21 wherein said devices are kiosks accessible to users in a merchant location

23. The method of claim 21 wherein said merchant location may be multiple locations in a geographic area

24. The method of claim 21 wherein said merchant location may comprise an online website and a physical location.

25. The method of claim 21, wherein the plurality of devices comprise a shell, and the information from the plurality of devices is obtained from the shell and sent to the cloud service via a network.
